(19) United States
(12) Patent Application Publication
(10) Pub. No.: US 2010/0097673 A1
(43) Pub. Date: Apr. 22, 2010

(54) HOLOGRAPHIC IMAGE DISPLAY SYSTEMS

(75) Inventor: Adrian James Cable, Cambridge (GB)

Correspondence Address: LOGINOV & ASSOCIATES, PLLC, 10 WATER STREET, CONCORD, NH, 03301, US

(73) Assignee: LIGHT BLUE OPTICS LTD, Cambridge, Cambridgeshire (GB)

(21) Appl. No.: 12/524,307

(22) PCT Filed: Dec. 12, 2007
(86) PCT No.: PCT/GB2007/050755

§ 371 Date: Nov. 30, 2009

(30) Foreign Application Priority Data
Jan. 24, 2007 (GB) 0701338.6

(51) Int. Cl. G03H 1/08

(52) U.S. Cl. 359/9

(57) ABSTRACT

This invention relates to methods and apparatus for the holographic display of images. We describe a method of compensating for spatial phase non-uniformities in a holographic image display system, the system including a substantially coherent light source illuminating an SLM (24), the method comprising sequentially displaying substantially the same hologram (40) at a plurality of different positions (40a, 40b) on said SLM (24) such that the displayed holographic images successively replayed by said differently positioned holograms (40a, 40b) average to provide a holographic displayed image with increased uniformity.

### FIELD OF THE INVENTION

This invention relates to methods and apparatus for the holographic display of images.

### BACKGROUND TO THE INVENTION

Many small, portable consumer electronic devices incorporate a graphical image display, generally a LCD (Liquid Crystal Display) screen. These include digital cameras, mobile phones, personal digital assistants/organisers, portable music devices such as the iPOD (trade mark), portable video devices, laptop computers and the like. In many cases it would be advantageous to be able to provide a larger and/or projected image but to date this has not been possible, primarily because of the size of the optical system needed for such a display.

We have previous described, for example in WO 2005/059660, a method for image projection and display using appropriately calculated computer generated holograms displayed upon dynamically addressable liquid crystal (LC) spatial light modulators (SLMs). Broadly speaking in this technique an image is displayed by displaying a plurality of holograms each of which spatially overlaps in the replay field and each of which, when viewed individually, would appear relatively noisy because noise is added by phase quantisation by the holographic transform of the image data. However when viewed in rapid succession the replay field images average together in the eye of a viewer to give the impression of a reduced (low) noise image. The noise in successive temporal subframes may either be pseudo-random (substantially independent) or the noise in a subframe may be dependent on the noise in one or more earlier subframes with the aim of at least partially canceling this out, or a combination of both may be employed. More details of such OSPR-type procedures are described later.

FIG. 1 shows an example a consumer electronic device 10 incorporating a holographic image projection module 12 to project a displayed image 14. Displayed image 14 comprises a plurality of holographically generated sub-images each of the same spatial extent as displayed image 14, and displayed rapidly in succession so as to give the appearance of the displayed image. Each holographic sub-frame is generated using an OSPR-type procedure.

FIG. 2a shows an example optical system for the holographic projection module of FIG. 1. Referring to FIG. 2a, a laser diode 20 (for example, at 532 nm), provides substantially collimated light 22 via a mirror 23 to a spatial light modulator (SLM) 24 such as a pixilated liquid crystal modulator. (As illustrated, the SLM is a reflective SLM but a transmissive SLM may also be employed). The SLM 24 phase modulates light 22 with a hologram and the phase modulated light is preferably provided to a demagnifying optical system 26. In the illustrated embodiment, optical system 26 comprises a pair of lenses (L3, L4) 28, 30 with respective focal lengths f₃, f₄, f₄<f₃, spaced apart at distance f₃+f₄. Optical system 26 increases the size of the projected holographic image (replay field R) by diverging the light forming the displayed image; it effectively reduces the pixel size of the modulator, thus increasing the diffraction angle. Lenses L₁ and L₂ form a beam-expansion pair which expands the beam from the light source so that it covers the whole surface of the modulator; depending on the relative size of the beam 22 and SLM 24 this may be omitted. A spatial filter may be included to filter out unwanted parts of the displayed image, for example a zero order undiffracted spot or a repeated first order (conjugate) image, which may appear as an upside down version of the displayed image, depending upon how the hologram for displaying the image is generated.

An example of a suitable binary phase SLM is the SXGA (1280×1024) reflective binary phase modulating ferroelectric liquid crystal SLM made by CRL Opto (Forth Dimension Displays Limited, of Scotland, UK). A ferroelectric liquid crystal SLM is advantageous because of its fast switching time; binary phase devices are convenient but devices with three or more quantized phases may also be employed (use of more than binary phase enables the conjugate image to be suppressed, see WO 2005/059660). A single optical arrangement can be used for beam expansion prior to modulation, and for demagnification of the modulated light. Thus the lens pair L1 and L2 and the lens pair L3 and L4 may comprise at least part of a common optical system, used in reverse, in conjunction with a reflective SLM, for light incident on and reflected from the SLM.

FIG. 2b illustrates such a lens sharing arrangement, in which a polariser is included to suppress interference between light travelling in different directions, that is into and out of the SLM. FIG. 2c shows, schematically, a preferred practical configuration of such a system, in which the laser diode (LD) does not obscure a central portion of the replay field. In the arrangement of FIG. 2c a polarising beam splitter 32 is used to direct the output, modulated light at 90 degrees on the image plane, and also to provide the function of the polariser in FIG. 2b.

FIG. 2d shows a further arrangement in which just L2/L3 is shared between the collimation and demagnification stages. In this example a waveplate 34 is also employed to rotate the polarisation of the incident beam for the beamsplitter. In the optical arrangements of each of FIGS. 2a-2d an intermediate image is formed between lenses L3 and L4 of the demagnification optics, at which the replay field (which is reproduced there) may be spatially filtered. Thus the arrangement of FIG. 2d includes an aperture 36 in the intermediate image plane of the demagnifying optics to block off the zero order (undiffracted light), the conjugate image, and higher diffraction orders.

A colour holographic projection system may be constructed by employing an optical system as described above to create three optical channels, red, blue and green superimposed to generate a colour image. In practice this is difficult because the different colour images must be aligned on the screen and a better approach is to create a combined red, green and blue beam and provide this to a common SLM and demagnifying optics. In this case, however, the different colour images are of different sizes; techniques to address this are described in our co-pending UK patent application no. GB0610784.1 filed 2 Jun. 2006, hereby incorporated by reference.

Referring again to FIG. 2a, a digital signal processor 100 has an input 102 to receive image data from the consumer electronic device defining the image to be displayed. The DSP 100 implements an OSPR-type procedure to generate phase hologram data for a plurality of holographic sub-frames which is provided from an output 104 of the DSP 100 to the SLM 24, optionally via a driver integrated circuit if needed. The DSP 100 drives SLM 24 to project a plurality of phase hologram sub-frames which combine to give the impression of displayed image 14 in the replay field (RPF). The DSP 100 may comprise dedicated hardware and/or Flash or other read-only memory storing processor control code to implement the hologram generation procedure.

OSPR-type techniques substantially reduce the amount of computation required for a high quality holographic image display and the temporal averaging reduces the level of perceived noise. However in practice the level of perceived noise can be an order of magnitude worse than that predicted by theory because of (non-) uniformity of the image (uniformity is determined by the reciprocal signal energy variance—approximately the noise in the light parts of the image).

The inventor has recognised that a substantial contribution to this arises because the optical surfaces in a practical system are imperfect and, especially, because the SLM is not perfectly flat. FIG. 3a shows, schematically, a cross-section through an SLM 24 illustrating how variations in height of the SLM surface (optical thickness of the SLM) result in variations in phase across the SLM surface. FIG. 3b shows, schematically, typical phase variations which can be seen when phase variations across an SLM are measured, illustrating islands 24a,b of increased (or decreased) height and hence phase. Another source of phase variation results from spatial phase variations across the illuminating laser beam.

One solution to this, in an OSPR-type system, would be to calculate more subframes for each image frame, but in practice one is often already calculating as many subframes per image frame as the processing hardware and/or software allows. Another potential possibility would be to characterise an individual SLM and then compensate for the phase imperfections when calculating a hologram, but it would be preferable to avoid this particularly in a manufacturing process.

The inventor has identified techniques which address this issue; moreover these are not restricted to OSPR-type procedures for hologram calculation. Background prior art can be found in G2,320,156A and U.S. Pat. No. 5,048,935.

### SUMMARY OF THE INVENTION

According to a first aspect of the invention there is therefore provided a method of compensating for spatial phase non-uniformities in a holographic image display system, the system including a substantially coherent light source illuminating an SLM, the method comprising displaying substantially the same hologram at a plurality of different positions on said SLM such that the displayed images replayed by said differently positioned holograms average to provide a displayed image with increased uniformity, in particular intensity uniformity.

Broadly speaking, the inventor has recognised that there is a property of holograms which can be exploited to compensate for spatial phase non-uniformities, which is that if a hologram is displaced perpendicular to the optical axis then there is no effect on the replayed image. This is because a position shift in the hologram plane merely results in a phase gradient in the image whereas the eye sees intensity. Thus one might imagine in a perfectly spatial-phase-uniform system that maintaining the SLM in a fixed position and moving the hologram on the display would have no visual effect. However, in a real system with spatial phase non-uniformities (aberrations) present on the display, at different positions on the display a particular pixel of the hologram, say the “top left hand corner” pixel of the hologram experiences different phase shifts due to said aberrations, resulting in independent intensity non-uniformities in the output image, which average out in the eye of an observer to provide an image with apparently enhanced intensity uniformity.

One might imagine that if the hologram were to be moved on the SLM to any substantial degree, the SLM would need to be much larger than the hologram in terms of numbers of pixels in the x- & y-directions. In fact the hologram can wrap around on the display so that the top left hand corner of the hologram may be “started” at any position on the SLM, once a boundary of the SLM is reached in the x- and/or y-direction the hologram wrapping around to continue at the opposite boundary. Optionally this wrap-around may neglect one or more rows/columns of boundary (edge) pixels of the SLM. The effect of placing the hologram in a variable location on the SLM is equivalent to moving the aberrations, effectively averaging these out.

In some embodiments the position of the hologram on the SLM may be dithered, that is moved over a relatively small range of positions, in which case the wrap-around may be omitted. However the degree to which the hologram is moved is preferably chosen taking into account the distance over which the phase across the SLM varies. In some measured SLMs a gradual variation over a substantial fraction of the area of the SLM could be seen, giving the appearance of “islands” of phase non-uniformity, and in embodiments, therefore, it is preferable to move the hologram over a distance of greater than 25%, 50% or 75% of the total number of pixels in the x- and/or y-direction.

In this latter case wrap-around is preferable. Although such wrap-around may be implemented in the software or hardware driving SLM, in other embodiments the SLM itself may incorporate a circular buffer. An SLM may incorporate a memory element for each pixel in which case each row and/or column of the SLM may be configured as a shift register and a circular buffer implemented by coupling the output at the end of a row/column back to its input. Such an arrangement has the advantage of reducing the load on the hologram calculation system since the hologram may be rapidly moved across the display, with wrap-around, by performing a circular shift along the row and/or column direction.

In some preferred embodiments the hologram is moved in both x- and y-directions to a set of substantially random (pseudo random) positions. In embodiments of the method at least five, at least ten or at least twenty different positions are employed for each subframe calculated, say, using an OSPR-type procedure.

Thus in another aspect the invention provides a spatial light modulator (SLM) for compensating for spatial phase non-uniformities in a holographic image display system, the SLM having a plurality of SLM pixels arranged in rows and columns, each having an associated pixel circuit including memory for storing pixel data indicating a value to display for the pixel on the SLM, and wherein the SLM further comprises circuitry to implement a circular shift register for one or both of said rows and columns to enable wrap-around rotation of said stored pixel data for displaying on said SLM.

The invention also provides a holographic image display system incorporating an SLM as described above.

The invention further provides a holographic image display system, the system including a substantially coherent light source illuminating an SLM, the system further comprising a mechanism for compensating for spatial phase non-uniformities, and wherein the mechanism is configured to move substantially the same hologram to a plurality of different positions on said SLM such that the displayed images replayed by said differently positioned holograms average to provide a displayed image with increased uniformity.

As previously mentioned, although in some preferred embodiments circuitry on the SLM performs a circular shift on the display data for the SLM, in embodiments this may instead be performed in software.

Thus the invention further provides processor control code to implement the above-described systems and methods, in particular on a data carrier such as a disk, CD- or DVD-ROM, programmed memory such as read-only memory (Firmware), or on a data carrier such as an optical or electrical signal carrier. Code (and/or data) to implement embodiments of the invention may comprise source, object or executable code in a conventional programming language (interpreted or compiled) such as C, or assembly code, code for setting up or controlling an ASIC (Application Specific Integrated Circuit) or FPGA (Field Programmable Gate Array), or code for a hardware description language such as Verilog (Trade Mark) or VHDL (Very high speed integrated circuit Hardware Description Language). As the skilled person will appreciate such code and/or data may be distributed between a plurality of coupled components in communication with one another.

Embodiments of the above described methods and systems may be incorporated into a consumer electronics device, or into an advertising or signage system, or into a helmet mounted or head-up display or, for example, an aircraft or automobile.

### BRIEF DESCRIPTION OF THE DRAWINGS

These and other aspects of the invention will now be further described, by way of example only, with reference to the accompanying figures in which:

FIG. 1 shows an example of a consumer electronic device incorporating a holographic projection module;

FIGS. 2a to 2d show, respectively, an example of an optical system for the holographic projection module of FIG. 1, and lens sharing arrangements used with a reflective SLM;

FIGS. 3a and 3b schematically show, respectively, a cross-section through an SLM illustrating variations in height and phase across the SLM surface, and typical phase variations across an SLM;

FIGS. 4a and 4b show, respectively, a block diagram of a hologram data calculation system, and operations performed within the hardware block of the hologram data calculation system;

FIG. 5 shows the energy spectra of a sample image before and after multiplication by a random phase matrix;

FIG. 6 shows an example of a hologram data calculation system with parallel quantisers for the simultaneous generation of two sub-frames from real and imaginary components of complex holographic sub-frame data respectively;

FIGS. 7a to 7c illustrate operation of an embodiment of a method according to the invention, and phase wrap-around;

FIGS. 8a and 8b illustrate averaging of phase non-uniformities; and

FIG. 9 shows an example of an SLM according to an embodiment of an aspect of the invention.

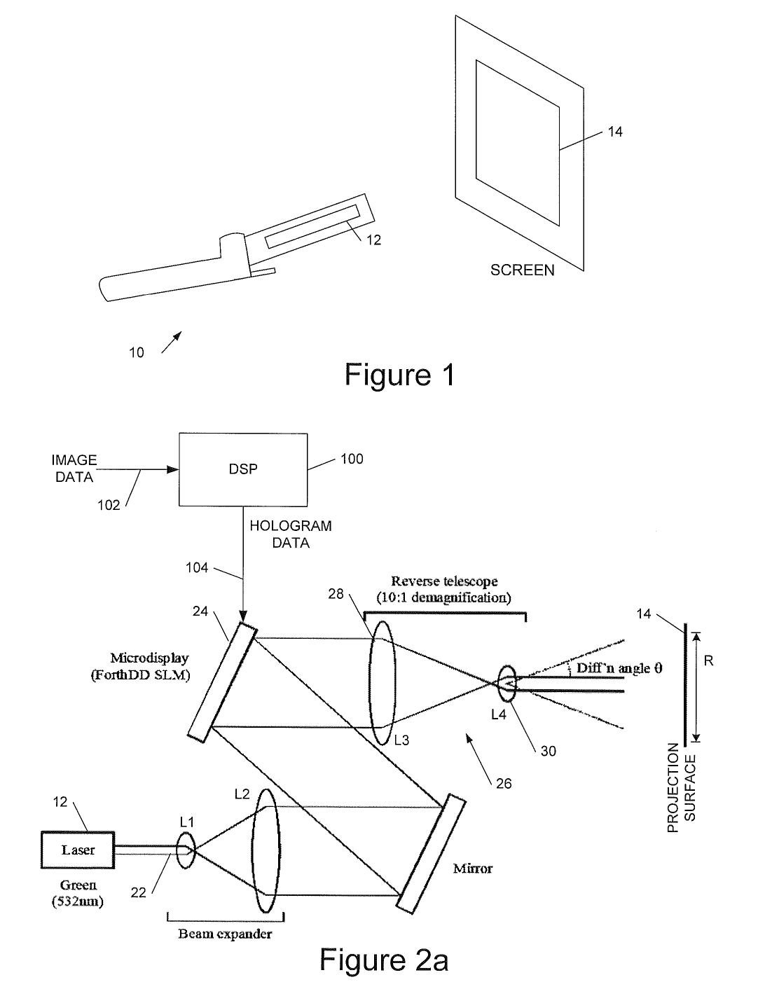

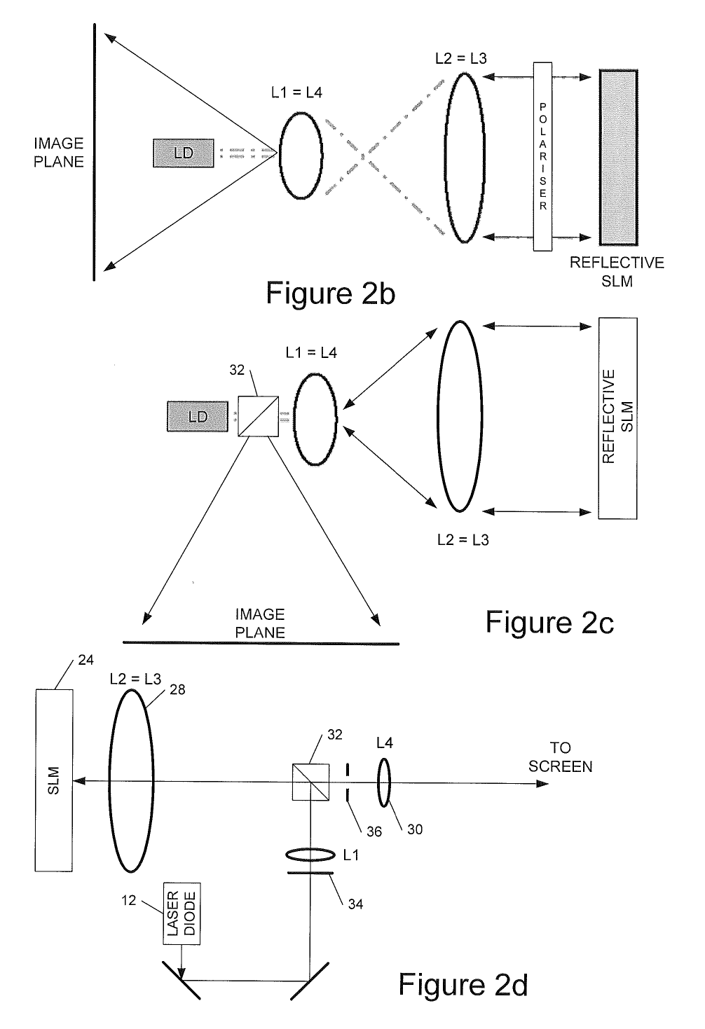

### DETAILED DESCRIPTION OF PREFERRED EMBODIMENTS

Some preferred implementations of the above described techniques are employed with an OSPR-type procedure, although applications of the techniques are not limited to such procedures. We therefore briefly describe such procedures. Further details can be found in GB0518912.1 (PCT/GB2006/050291) and GB0601481.5 (PCT/GB2007/050037), both hereby incorporated by reference.

### OSPR

Broadly speaking in our preferred method the SLM is modulated with holographic data approximating a hologram of the image to be displayed. However this holographic data is chosen in a special way, the displayed image being made up of a plurality of temporal sub-frames, each generated by modulating the SLM with a respective sub-frame hologram. These sub-frames are displayed successively and sufficiently fast that in the eye of a (human) observer the sub-frames (each of which have the spatial extent of the displayed image) are integrated together to create the desired image for display.

Each of the sub-frame holograms may itself be relatively noisy, for example as a result of quantising the holographic data into two (binary) or more phases, but temporal averaging amongst the sub-frames reduces the perceived level of noise. Embodiments of such a system can provide visually high quality displays even though each sub-frame, were it to be viewed separately, would appear relatively noisy.

The procedure is a method of generating, for each still or video frame I=I_{xy}, sets of N binary-phase holograms h⁽¹⁾ . . . h^{(N)}. In embodiments such sets of holograms form replay fields that exhibit mutually independent additive noise. An example is shown below:

$$1. Let {G}_{xy}^{( n )} = {I}_{xy} exp ( j {ϕ}_{xy}^{( n )} ) where {ϕ}_{xy}^{( n )} is uniformly distributed between 0$$

$$and 2 π for 1 \leq n \leq N / 2 and 1 \leq x , y \leq m$$

$$2. Let {g}_{uv}^{( n )} = {F}^{- 1} [ {G}_{xy}^{( n )} ] where {F}^{- 1} represents the two \text{-} dimensional$$

$$inverse Fourier transform operator , for 1 \leq n \leq N / 2$$

$$3. Let {m}_{uv}^{( n )} = \{ {g}_{uv}^{( n )} \} for 1 \leq n \leq N / 2$$

$$4. Let {m}_{uv}^{( n + N / 2 )} = \{ {g}_{uv}^{( n )} \} for 1 \leq n \leq N / 2$$

$$5. Let {h}_{uv}^{( n )} = \{ \begin{matrix}- 1 & if {m}_{uv}^{( n )} < {Q}^{( n )} \\ 1 & if {m}_{uv}^{( n )} \geq {Q}^{( n )}\end{matrix} \\ where {Q}^{( n )} = median ( {m}_{uv}^{( n )} ) and 1 \leq n \leq N$$

Step 1 forms N targets G_{xy}⁽ⁿ⁾ equal to the amplitude of the supplied intensity target I_{xy}, but with independent identically-distributed (i.i.t.), uniformly-random phase. Step 2 computes the N corresponding full complex Fourier transform holograms gᵤᵥ⁽ⁿ⁾. Steps 3 and 4 compute the real part and imaginary part of the holograms, respectively. Binarisation of each of the real and imaginary parts of the holograms is then performed in step 5: thresholding around the median of mᵤᵥ⁽ⁿ⁾ ensures equal numbers of −1 and 1 points are present in the holograms, achieving DC balance (by definition) and also minimal reconstruction error. The median value of mᵤᵥ⁽ⁿ⁾ may be assumed to be zero with minimal effect on perceived image quality.

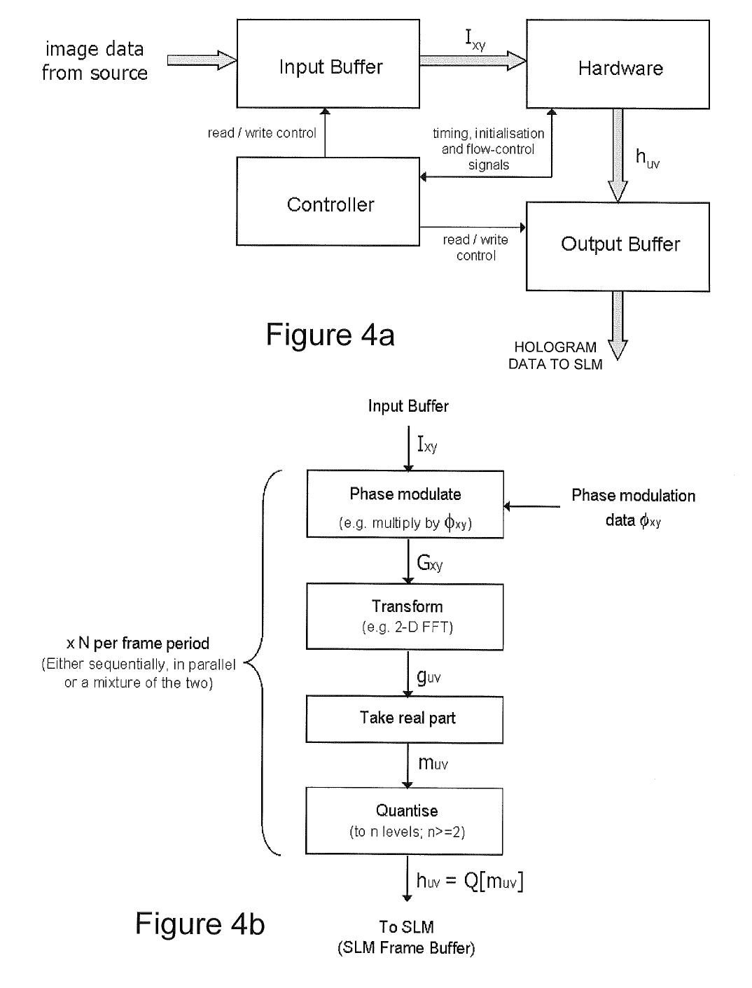

FIG. 4a (from GB0511962.3, filed 14 Jun. 2005, incorporated by reference) shows a block diagram of a hologram data calculation system configured to implement this procedure. The input to the system is preferably image data from a source such as a computer, although other sources are equally applicable. The input data is temporarily stored in one or more input buffer, with control signals for this process being supplied from one or more controller units within the system. The input (and output) buffers preferably comprise dual-port memory such that data may be written into the buffer and read out from the buffer simultaneously. The control signals comprise timing, initialisation and flow-control information and preferably ensure that one or more holographic sub-frames are produced and sent to the SLM per video frame period.

The output from the input comprises an image frame, labelled I, and this becomes the input to a hardware block (although in other embodiments some or all of the processing may be performed in software). The hardware block performs a series of operations on each of the aforementioned image frames, I, and for each one produces one or more holographic sub-frames, h, which are sent to one or more output buffer. The sub-frames are supplied from the output buffer to a display device, such as a SLM, optionally via a driver chip.

FIG. 4b shows details of the hardware block of FIG. 4a; this comprises a set of elements designed to generate one or more holographic sub-frames for each image frame that is supplied to the block. Preferably one image frame, I_{xy}, is supplied one or more times per video frame period as an input. Each image frame, I_{xy}, is then used to produce one or more holographic sub-frames by means of a set of operations comprising one or more of: a phase modulation stage, a space-frequency transformation stage and a quantisation stage. In embodiments, a set of N sub-frames, where N is greater than or equal to one, is generated per frame period by means of using either one sequential set of the aforementioned operations, or a several sets of such operations acting in parallel on different sub-frames, or a mixture of these two approaches.

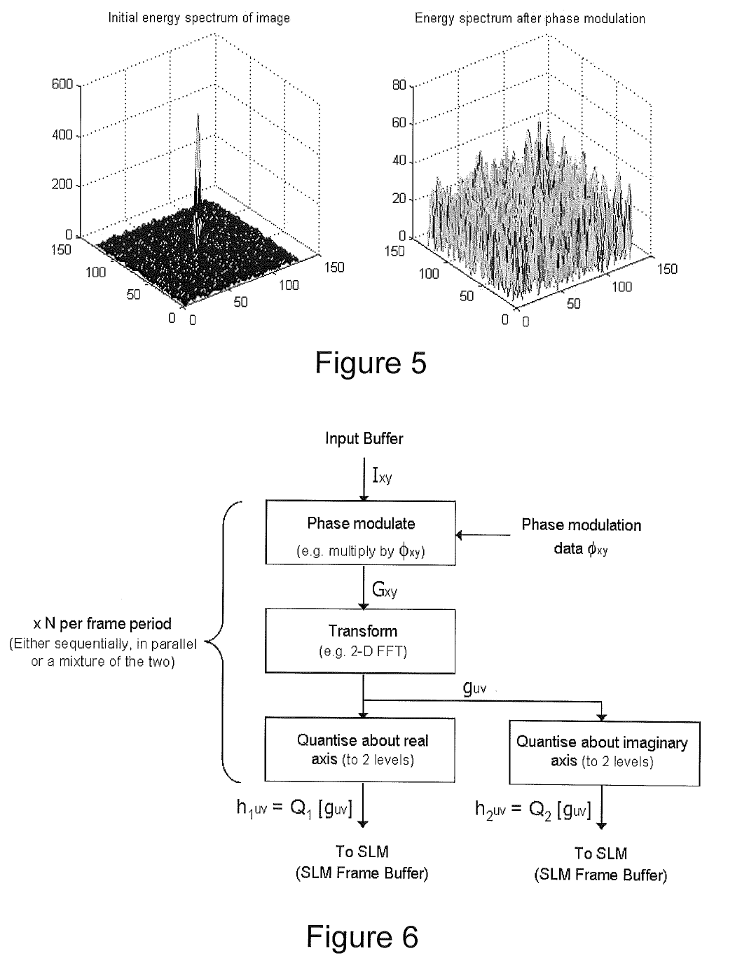

The purpose of the phase-modulation block is to redistribute the energy of the input frame in the spatial-frequency domain, such that improvements in final image quality are obtained after performing later operations. FIG. 5 shows an example of how the energy of a sample image is distributed before and after a phase-modulation stage in which a pseudo-random phase distribution is used. It can be seen that modulating an image by such a phase distribution has the effect of redistributing the energy more evenly throughout the spatial-frequency domain. The skilled person will appreciate that there are many ways in which pseudo-random binary-phase modulation data may be generated (for example, a shift register with feedback).

The quantisation block takes complex hologram data, which is produced as the output of the preceding space-frequency transform block, and maps it to a restricted set of values, which correspond to actual modulation levels that can be achieved on a target SLM (the different quantised phase retardation levels may need not have a regular distribution). The number of quantisation levels may be set at two, for example for an SLM producing phase retardations of 0 or π at each pixel.

In some preferred embodiments the quantiser is configured to separately quantise real and imaginary components of the holographic sub-frame data to generate a pair of holographic sub-frames, each with two (or more) phase-retardation levels, for the output buffer. FIG. 6 shows an example of such a system. It can be shown that for discretely pixilated fields, the real and imaginary components of the complex holographic sub-frame data are uncorrelated, which is why it is valid to treat the real and imaginary components independently and produce two uncorrelated holographic sub-frames.

In the OSPR approach we have described above subframe holograms are generated independently and thus exhibit independent noise. In control terms, this is an open-loop system. However one might expect that better results could be obtained if, instead, the generation process for each subframe took into account the noise generated by the previous subframes in order to cancel it out, effectively “feeding back” the perceived image formed after, say, n OSPR frames to stage n+1 of the algorithm. In control terms, this is a closed-loop system.

One example of this approach comprises an adaptive OSPR algorithm which uses feedback as follows: each stage n of the algorithm calculates the noise resulting from the previously-generated holograms H₁ to Hₙ₋₁, and factors this noise into the generation of the hologram Hₙ to cancel it out. As a result, it can be shown that noise variance falls as 1/N². An example procedure takes as input a target image T, and a parameter N specifying the desired number of hologram subframes to produce, and outputs a set of N holograms H₁ to H_{N} which, when displayed sequentially at an appropriate rate, form as a far-field image a visual representation of T which is perceived as high quality. More details can be found in GB0518912.1 and GB0601481.5 (ibid), hereby incorporated by reference in their entirety.

### Phase Non-Uniformity Compensation

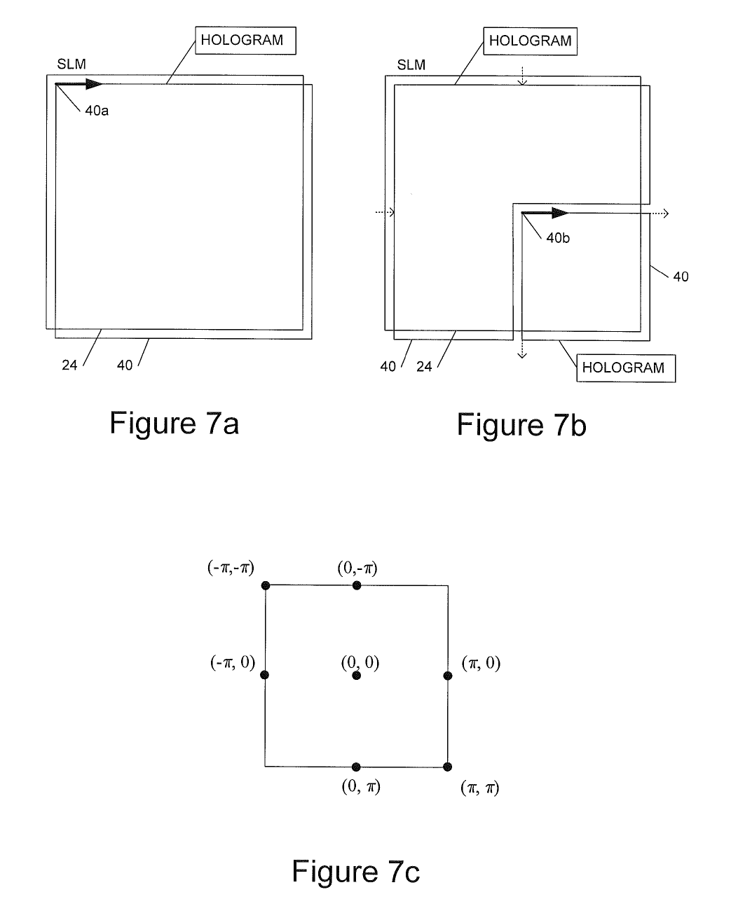

Referring now to FIGS. 7a to 7c, these schematically illustrate the operation of an embodiment of a method according to the invention. In the Figures a hologram 40 is displayed at two different positions on SLM 24. In FIG. 7a the top left hand corner of the hologram 40a is displayed at the top left hand corner of the SLM (the arrow indicating data for the first row of pixels of the hologram). In FIG. 7b the same hologram is displayed but this time the top left hand corner of the hologram starts in the centre of the SLM, the hologram wrapping around from right to left and from bottom to top of the SLM. FIG. 7c schematically illustrates the wrap-around process, illustrating that for a hologram, because the phase angle effectively represents an angle on the circle, a phase of π+Δ is equivalent to a phase of −π+Δ so that writing off one edge of the SLM is equivalent to writing onto the previous edge.

Some benefit can be obtained with just two different positions of the hologram on the SLM but preferably a larger number is employed, for example ten different positions in order to provide, potentially, a tenfold increase in uniformity. The degree of movement of a hologram depends upon the expected phase non-uniformity to be addressed and should preferably be sufficient to average out most of this phase non-uniformity. For example the hologram may be moved as far as an average distance over which a phase change of π is expected. In general the number of positions and degree of movement of the hologram may be chosen by routine experiment and/or characterisation of one or a batch of SLMs.

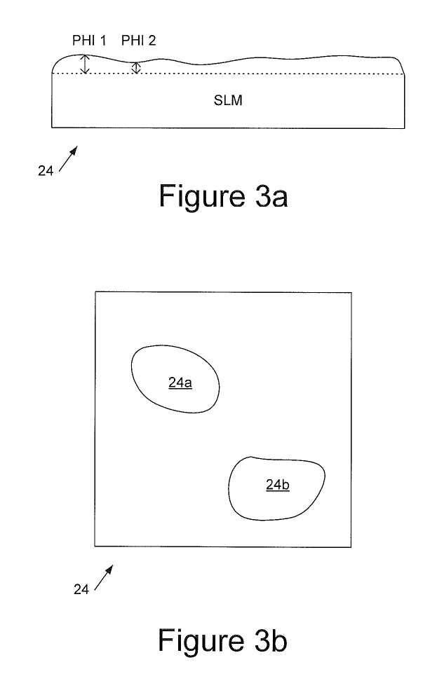

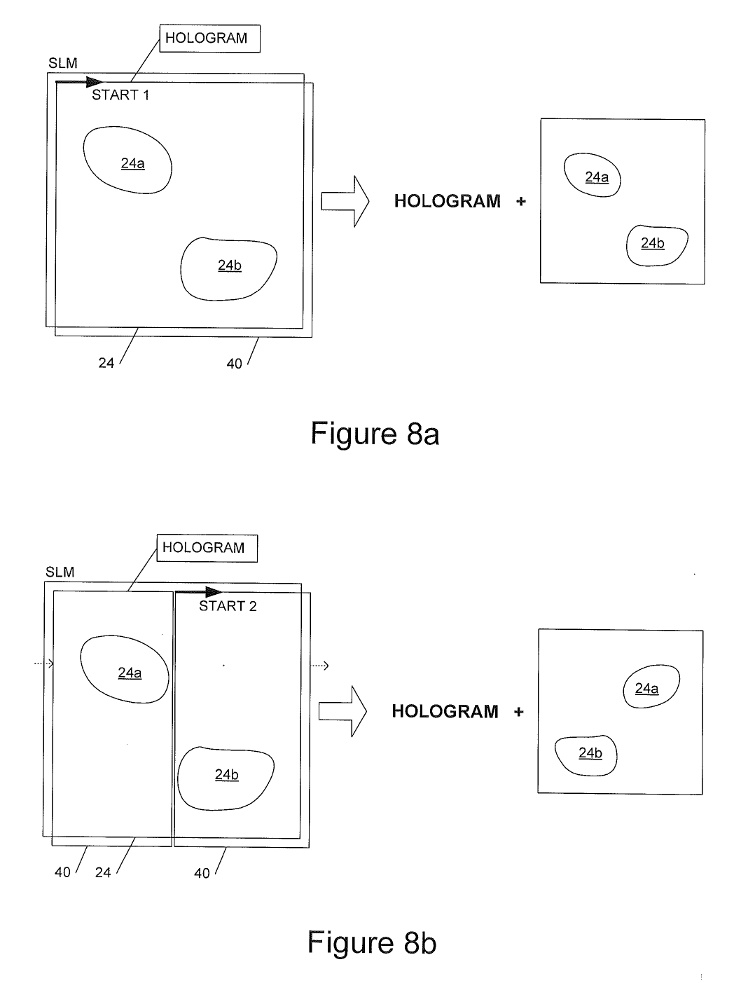

FIGS. 8a and 8b illustrate, schematically, how the islands of phase non-uniformity shown in FIG. 3b are effectively averaged out by displaying a hologram 40 at two different positions on SLM 24. It can be seen that the effects of the non-uniform islands 24a, b change for each position of the hologram and thus effectively just add noise which is reduced by displaying the hologram at different positions in a similar way to that in which OSPR subframes reduce noise, as already described.

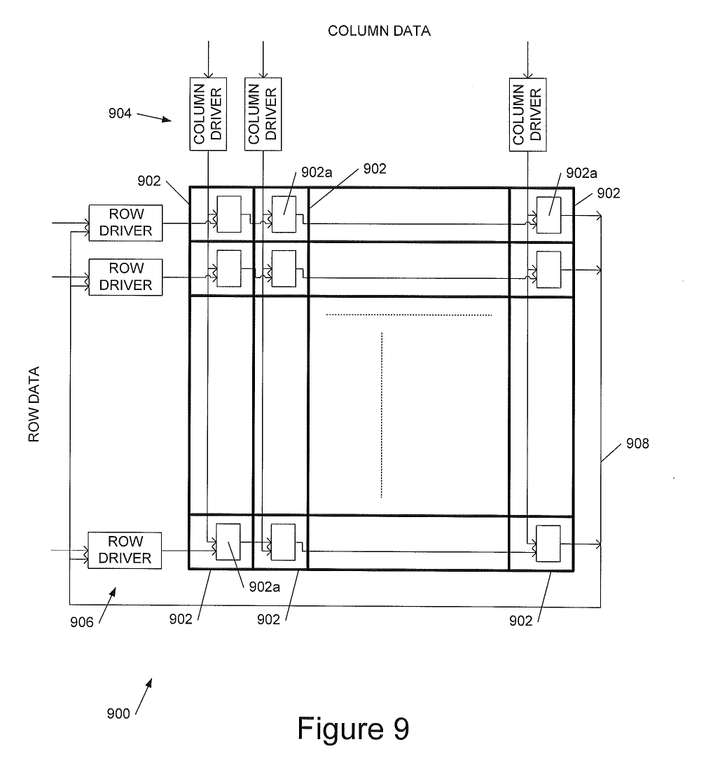

Referring now to FIG. 9, this shows an embodiment of an SLM 900 useful for implementing a method as described above. In embodiments the spatial light modulator comprises an LCOS (Liquid Crystal On Silicon) SLM which comprises a silicon substrate bearing pixel circuitry and other associated circuitry over which is fabricated a metal layer serving as a mirror and electrodes, a layer of liquid crystal material being provided over this metal layer and then covered with glass. The SLM has a plurality of pixels 902 each with associated pixel circuitry 902a comprising at least a one-hit memory element. The pixels are driven by respective column drivers 904 and row drivers 906. Preferably the SLM 900 comprises a ferroelectric liquid crystal SLM, in particular a binary FLC SLM.

The inventor has recognised that because the liquid crystal switches faster than data can be loaded into the display it is advantageous to be able to load the data just once and to move the hologram, for example as shown in FIGS. 7a and 7b, by performing shift operations on the SLM itself. Thus the pixels of the rows of SLM 900 are configured as a shift register and a feedback path 908 provides a circular connection to enable the above-described wrap-around. Additionally or alternatively, columns of the display may also be configured as a shift register, preferably with wrap-around. Thus in embodiments of the display once the data for a hologram has been loaded into the display, the SLM can be clocked to rapidly shift the position of the hologram on the display. The use of an LCOS SLM facilitates incorporating the shift register circuitry onto the display itself but the skilled person will understand that this circuitry could also be provided externally to the display.

Applications for the described techniques and modulators include, but are not limited to the following: mobile phone; PDA; laptop; digital camera; digital video camera; games console; in-car cinema; navigation systems (in-car or personal e.g. wristwatch GPS); head-up and helmet-mounted displays for automobiles and aviation; watch; personal media player (e.g. MP3 player, personal video player); dashboard mounted display; laser light show box; personal video projector (a “video iPod®” concept); advertising and signage systems; computer (including desktop); remote control unit; an architectural fixture incorporating a holographic image display system; more generally any device where it is desirable to share pictures and/or for more than one person at once to view an image.

No doubt many effective alternatives will occur to the skilled person and it will be understood that the invention is not limited to the described embodiments and encompasses modifications apparent to those skilled in the art lying within the spirit and scope of the claims appended hereto.

1. A method of compensating for spatial phase non-uniformities in a holographic image display system, the system including a substantially coherent light source illuminating an SLM, the method comprising displaying substantially the same hologram at a plurality of different positions on said SLM such that the displayed images replayed by said differently positioned holograms average to provide a displayed image with increased uniformity.

2. A method as claimed in claim 1 wherein said image is displayed to an observer, and wherein said images are displayed sufficiently fast to average in the observer's eye to be perceived as a single increased uniformity image.

3. A method as claimed in claim 1 wherein said displaying of said hologram at said different positions comprises wrapping around said hologram from one boundary to another of said SLM.

4. A method as claimed in claim 1 wherein said SLM has a plurality of pixels arranged in rows and columns and wherein said displaying at different positions comprises performing a circular shift of pixel data in said SLM defining values of said pixels in one or both of a direction of said rows and a direction of said columns.

5. A method as claimed in claim 4 wherein said circular shift is performed by circuitry associated with said SLM.

6. A method as claimed in claim 1 wherein said SLM comprises a ferroelectric liquid crystal SLM.

7. A method as claimed in claim 6 wherein said SLM comprises a binary SLM.

8. A method as claimed in claim 1 wherein a set of said positions comprises a substantially random set of positions displaced in one or both of two directions substantially perpendicular to a direction defined by said illuminating light.

9. A method as claimed in claim 1 wherein a said hologram comprises a holographic subframe for an OSPR-type procedure.

10. A holographic image display system, the system including a substantially coherent light source illuminating an SLM, the system further comprising a mechanism for compensating for spatial phase non-uniformities, and wherein the mechanism is configured to move substantially the same hologram to a plurality of different positions on said SLM such that the displayed images replayed by said differently positioned holograms average to provide a displayed image with increased uniformity.

11. A holographic image display system as claimed in claim 10 wherein when said hologram is displayed at said different positions the hologram wraps around on said display.

12. A holographic image display system as claimed in claim 10 wherein said positions comprise a substantially random set of displacements in one or both of two orthogonal directions on said display.

13. A holographic image display system as claimed in claim 10 wherein said mechanism comprises circuitry associated with said SLM.

14. A holographic image display system as claimed in claim 10 wherein said SLM comprises a binary ferroelectric liquid crystal SLM.

15. A holographic image display system as claimed in claim 10 wherein said system comprises an OSPR-type system and wherein said hologram comprises a hologram for a temporal subframe of an OSPR-type procedure.

16. A spatial light modulator (SLM) for compensating for spatial phase non-uniformities in a holographic image display system, the SLM having a plurality of SLM pixels arranged in rows and columns, each having an associated pixel circuit including memory for storing pixel data indicating a value to display for the pixel on the SLM, and wherein the SLM further comprises circuitry to implement a circular shift register for one or both of said rows and columns to enable wrap-around rotation of said stored pixel data for displaying on said SLM.

17. A holographic image display system, the system including a spatial light modulator (SLM) as claimed in claim 16.
